(19) United States
(12) Patent Application Publication
(10) Pub. No.: US 2012/0227703 A1
(43) Pub. Date: Sep. 13, 2012

(54) ROTARY ENGINE WITH ROTARY POWER HEADS

(76) Inventor: John Larry Gaither, Camden, NC (US)

(21) Appl. No.: 13/417,197

(22) Filed: Mar. 9, 2012

Related U.S. Application Data
(60) Provisional application No. 61/450,654, filed on Mar. 9, 2011.

(51) Int. Cl. F02B 53/04; F02B 53/12

(52) U.S. Cl. 123/210; 123/200

(57) ABSTRACT

A rotary engine includes a casing having a large circular boring, a small circular boring, whereby the small circular boring interconnects with the large circular boring. A piston rotor is carried in a rotating manner within the large circular boring in the casing. A power head, ported to pass exhaust gases thru it's hollow center shaft, is carried in a rotating manner within the small circular boring in the casing. The piston rotor and the power head are meshed together to properly rotate during operation, with the piston rotor rotating counterclockwise and the power head rotating clockwise. A second powerhead can also be used.

### CROSS-REFERENCE TO RELATED APPLICATION

This application claims the benefit of Provisional Patent Application No. 61/450,654, filed on Mar. 9, 2011, in the United States Patent & Trademark Office, the disclosure of which is incorporated herein by reference.

### BACKGROUND OF THE INVENTION

1. Field of the Invention

The present invention relates to a rotating internal combustion engine, and more particularly, a rotary engine.

The ROTARY ENGINE WITH ROTARY POWER HEADS is a device designed to convert the heat energy stored in a fuel into mechanical energy through a process of combustion. The present invention provides an inexpensive, high torque, prime mover for everything from weed eaters to high performance aircraft. The process is one of pure rotation, it has no reciprocating parts, and is of a simple construction. This engine can be used to great advantage in any application that can be or is powered by conventional reciprocating engines and many turbines. The ROTARY ENGINE inherently supercharges and has perfect scavenging of exhaust gases. The ROTARY ENGINE combines the high-speed capabilities of turbines with the positive displacement character of reciprocating engines.

2. Description of the Prior Art

Other types of engines with similar capabilities have to be constructed from stronger, more expensive materials. These engines contain many more moving parts, which have to be machined with much greater difficulty and associated tooling expense. The weight and bulk of the other engines can make them unacceptable or undesirable for some applications. A more efficient alternative is needed.

Numerous innovations for rotary displacement engines have been provided in the prior art that will be described. Even though these innovations may be suitable for the specific individual purposes to which they address, however, they differ from the present invention.

A FIRST EXAMPLE, U.S. Pat. No. 4,144,004, issued on Mar. 13, 1979, to Edwards teaches a positive displacement engine utilizing interlocking vaned rotors and providing for the virtually complete exclusion of spent vapors following the expansion cycle.

A SECOND EXAMPLE, U.S. Pat. No. 5,362,219, issued on Nov. 8, 1994, to Paul et al. teaches a rotary air compressor with a housing forming an epitrochoidal chamber in which a multilobed rotor with a ring gear eccentrically rotates on an internal central gear in the housing, the rotor dividing the chamber into multiple sub-chambers of changing volume as the rotor rotates, the chamber having intake ports of variable size opening to change the quantity of gas that is compressible and outlet ports having spring biased plunger valves to prevent flow of discharged compressed air back into the compressor.

A THIRD EXAMPLE, U.S. Pat. No. 6,142,758, issued on Nov. 7, 2000, to Taggett teaches a rotary positive displacement engine that includes one or more power rotors, which are acted upon by a pressurized charge of gas, such as steam, and an annular barrier rotor geared for synchronous rotation with the power rotors. The rotors rotate within intersecting cylindrical bores in the engine housing. The power rotors have cylindrical outer surfaces from which opposed vanes extend which are acted upon by the powering charge. The barrier rotor has an outer cylindrical surface, located in close proximity to the cylindrical surface of the power rotors, and ports for delivering the powering charge to the power rotors. The barrier rotor thus forms both a charge delivery mechanism and a barrier between the exhaust ports and the expanding gas powering the engine. Located within the barrier rotor is a stator which has ports in fluid communication with the ports in the barrier rotor when the respective ports are aligned. The location of the barrier rotor is adjustable with respect to the power rotors to permit the clearances between the confronting surfaces of the barrier rotor and the power rotors to be adjusted to extremely tight tolerances under operating conditions, which provides high efficiency operation with very low amounts of contamination of the exhaust gas.

A FOURTH EXAMPLE, U.S. Patent Office Publication No. 2002/0157636, published on Oct. 31, 2002, to Klassen teaches a two-dimensional rotary displacement device which comprises a housing, an outer rotor and at least one inner rotor. The axes of rotation of the outer rotor and the at least one inner rotor are parallel. A predefined geometrical relationship exists between the outer and inner rotors such that the scale of operative circumference (or diameter) from the inner rotor with respect to the outer rotor is preferably an integer value. In one embodiment, the device is used as a compressor that positively displaces a gas. In a modified embodiment, the device includes an exit port, which has a location that can be adjusted with respect to the housing and is adjustable so as to decrease the pressure differential between an exit chamber and the exit pressure. In another embodiment, the device can be used as an external combustion engine wherein compressed gas is discharged from an exit chamber to a combustion chamber where the volume of gas is increased due to heating of the gas and a portion of the discharge gas is directed to the rotor assembly and the remaining volume of gas can be used for a “hot blow” thrust or other use or directed to an additional rotor assembly to induce a torque to an output shaft attached to the outer rotor of one or both of the rotor assemblies. In another embodiment, a portion of the compressed gas can be used for “cold blow” thrust or other purpose instead of directing all of the compressed gas through the combustor.

A FIFTH EXAMPLE, U.S. Patent Office Publication No. 2006/0120895, published on Jun. 8, 2006, to Gardner teaches a rotary positive displacement engine includes a compressor housing having a compression chamber therein and a rotor housing having a rotor chamber therein. The rotor housing and compressor housing are in fluid communication and define a main housing having a first end plate, an opposing second end plate, and a center divider plate interposed therebetween, wherein the first and second end, and center divider plates are connected to the main housing. An output member is rotatably supported within the main housing and extends axially therefrom. A compressor is disposed within the compressor chamber and is mounted on the output member. An engine rotor is disposed within the rotor chamber and is mounted on the output member. An engine rotor working end portion defines a combustion chamber, wherein fuel is ignited to rotate the engine rotor, which, in turn, rotates the output shaft.

It is apparent now that numerous innovations for rotary displacement engines have been provided in the prior art that are adequate for various purposes. Furthermore, even though these innovations may be suitable for the specific individual purposes to which they address, they would be inferior to the rotary engine for the purposes of the present invention as heretofore described.

### SUMMARY OF THE INVENTION

AN OBJECT of the rotary engine is to provide a rotary engine that avoids the disadvantages of the prior art.

ANOTHER OBJECT of the rotary is to provide a high torque rotary engine that is simple and inexpensive to manufacture.

STILL ANOTHER OBJECT of the rotary engine is to provide a rotary engine that is simple to use and maintain.

BRIEFLY STATED, yet another object of the present invention is to provide a rotary engine which comprises a casing having a large circular boring and a small circular boring whereby the small circular boring interconnects with the large circular boring. A piston rotor rotates within the large circular boring in the casing. A power head rotates within the small circular boring in the casing. Proper rotational relationship between the piston rotor and the power head is maintained by a simple gear train external to this casing. The piston rotor rotates counterclockwise and the power head rotates clockwise.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a front view of the present invention with the upper portion broken away;

FIG. 2 is a front view of the present invention with the front plate removed therefrom, showing how the fuel air mixture can be compressed in the compression chamber;

FIG. 3 is a front view similar to FIG. 2, showing how the fuel air mixture can be compressed to its maximum density in the compression chamber;

FIG. 4 is a front view similar to FIG. 3, showing how the piston rotor can be rotated counterclockwise by the rapidly expanding gases; and

FIG. 5A is a front view similar to FIG. 4 with the lower portion broken away, showing how the exhaust gases can flow out through the hollow shaft in the power head.

FIG. 5B is a perspective view similar of a power head, showing how the exhaust gases can flow out through the hollow shaft in the power head.

FIG. 6 is a circuit diagram of CDI ignition.

FIG. 7A is a backview of a gear train coupling to the power head and rotor shaft.

FIG. 7B is a front view similar to FIG. 3 with the phantom gear train on the back.

FIG. 8 is a front view similar to FIG. 3, showing how the engine has two symmetric power heads.

FIG. 9 is a backview of a gear train coupling to the first power head, a rotor shaft, and a second power head.

### REFERENCE NUMERALS UTILIZED IN THE DRAWING

110 rotary engine

112 casing in rotary engine 110

114 large circular boring in casing 112

116 small circular boring in casing 112

118 exhaust port in power head 122

120 piston rotor in large circular boring 114

122 power head in small circular boring ported for exhaust flow

122.1 powerhead shaft

124 shaft in piston rotor 120

126 depression on circumference for intake and compression 128

128 on circumference of piston rotor 120

130 compression chamber between depression 126 and large circular boring 114

132 intake collector ring on piston rotor 120

134 front plate on casing 112

136 carburetor on front plate 134

137 fresh air intake on carburetor 136

138 fuel intake stem on carburetor 136

140 solid state ignition system on casing 112

140.1 plug/coil module

140.2 ignition reference sensor

140.3 battery/alternator

140.4 ignition switch

140.5 CDI module

142 Involute pumping gases from collector ring to intake/compression chamber 130

144 gear train

146 bevel gear mounted on main rotor shaft

148 bevel gear mounted on power head shaft

150 shaft with bevel gears on each end

### DETAILED DESCRIPTION OF THE PREFERRED EMBODIMENT

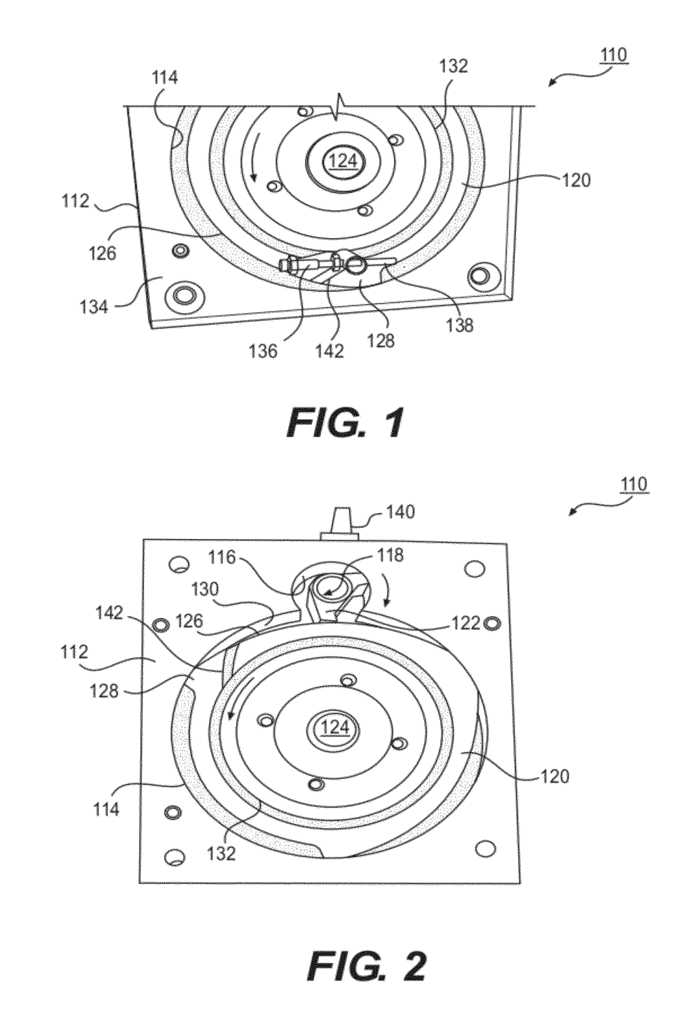

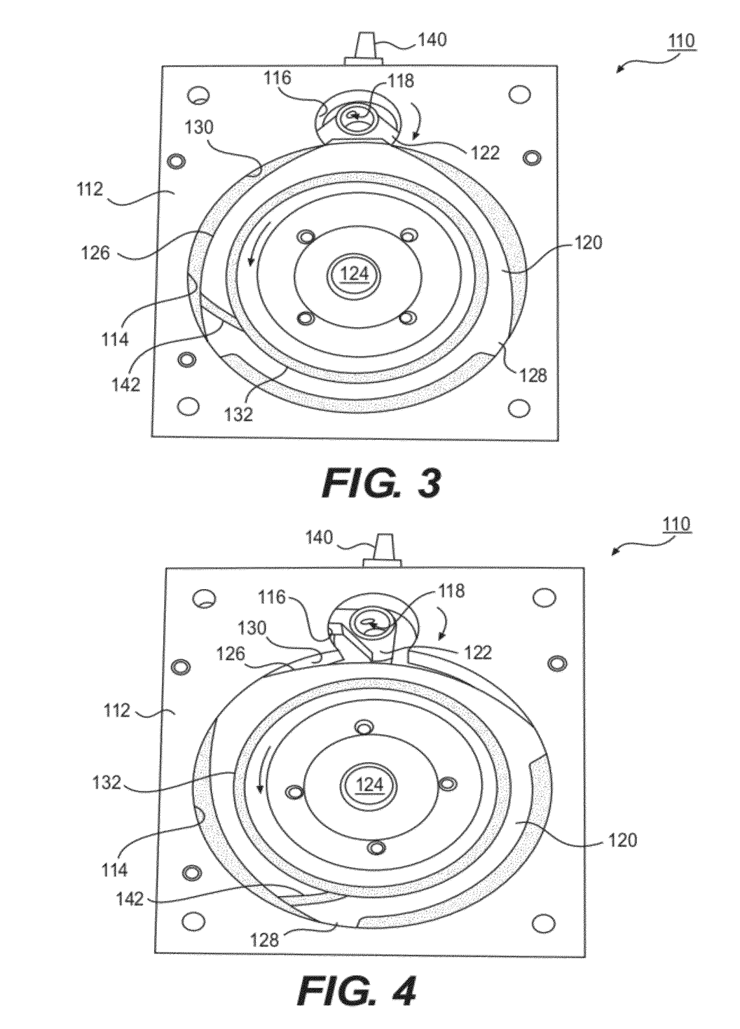

The present invention, as shown in FIGS. 1, 2, 3, 4 and 5A is a rotary engine 110 which comprises a casing 112 having a large circular boring 114, a small circular boring 116, whereby the small circular boring 116 interconnects with the large circular boring 114. A piston rotor 120 is carried in a rotating manner within the large circular boring 114 in the casing 112. A power head 122 is carried in a rotating manner within the small circular boring 116 in the casing 112. The piston rotor and the powerhead maintain a precise rotational relationship 1:1 ratio with each other thru a gear train mounted externally to this chamber (not shown) . The piston rotor rotates counter clockwise while the powerhead rotates clockwise.

A shaft 124 extends centrally from the piston rotor 120 for power output therefrom. The piston rotor 120 has a depression 126 formed on its circumference 128 to produce a compression chamber 130 between the depression 126 and the large circular boring 114 in the casing 112. An involute 142 integrated on the piston rotor 120 can move collector ring gases into the compression chamber 130.

As shown in FIG. 1, a front plate 134 is mounted on the casing 112. A carburetor 136 having a fresh air intake 137 and a fuel intake 138 is affixed to the front plate 134 to supply a fuel air mixture into the collector ring 132. A solid state ignition system 140 on the casing 112 ignites the compressed fuel air mixture at the appropriate time in the cycle, at or near top dead center. Exhaust gases travel through the power head 122 and exit out of the exhaust port 118 in the power head 122. The casing 112 is fabricated of a suitable durable material, such as aluminum, steel or ceramic.

In review, the rotary engine 110 is a high efficiency, high torque, engine that is designed to be used for a wide variety of applications. The present invention comprises a casing 112 that is cast and/or machined of a suitable durable material, such as aluminum, steel, or ceramic. The casing 112 houses in a large circular boring 114 a piston rotor 120 and a power head 122. A shaft 124 runs through the center of the piston rotor 120 for power output and upon which additional power packs may be mounted as dictated by power and design requirements. The power head 122 with the exhaust port 118 affects the desired compression ratio and is installed in a small circular boring 116.

An involute 142 is cast into or otherwise integrated with the piston rotor 120 to help move the fuel air mixture from the collector ring 132 into the compression chamber 130 between a depression 126 on a circumference 128 of the piston rotor 120 and the large boring in the casing. A carburetor 136 having a fresh air intake 137 and a fuel intake 138 is mounted on a front plate 134 to provide a fuel air mixture.

A solid state ignition system 140 mounted on casing 112 ignites the fuel air mixture in the case of fuel requiring a spark. Compression ignition provides the igniting source for fuels of that type. The rotary engine can have the size of 8 inches (W), 10 inches (L) and 12 inches (H). The engine can rotate from 300 revolution per minutes (rpm) to 20,000 rpm. The volume's compression chamber can be 50 cc-5000 cc. The measurements and other specifications will vary widely depending on power and speed demands on the particular application.

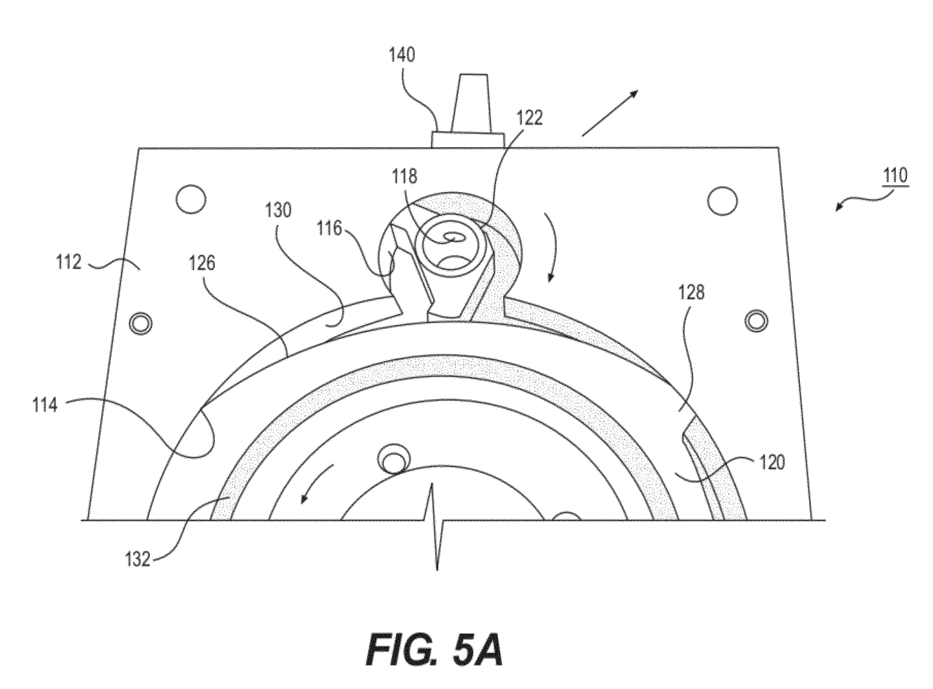

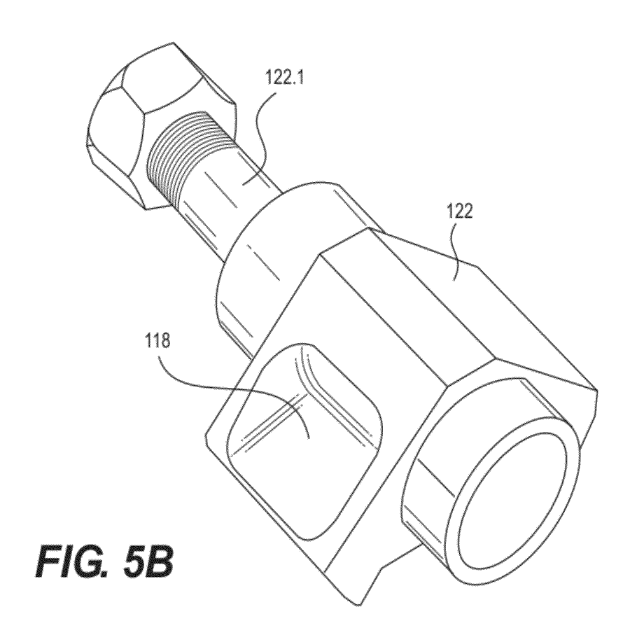

As shown in FIG. 5B, the power head 122 with the exhaust port 118 and a powerhead shaft 122.1.

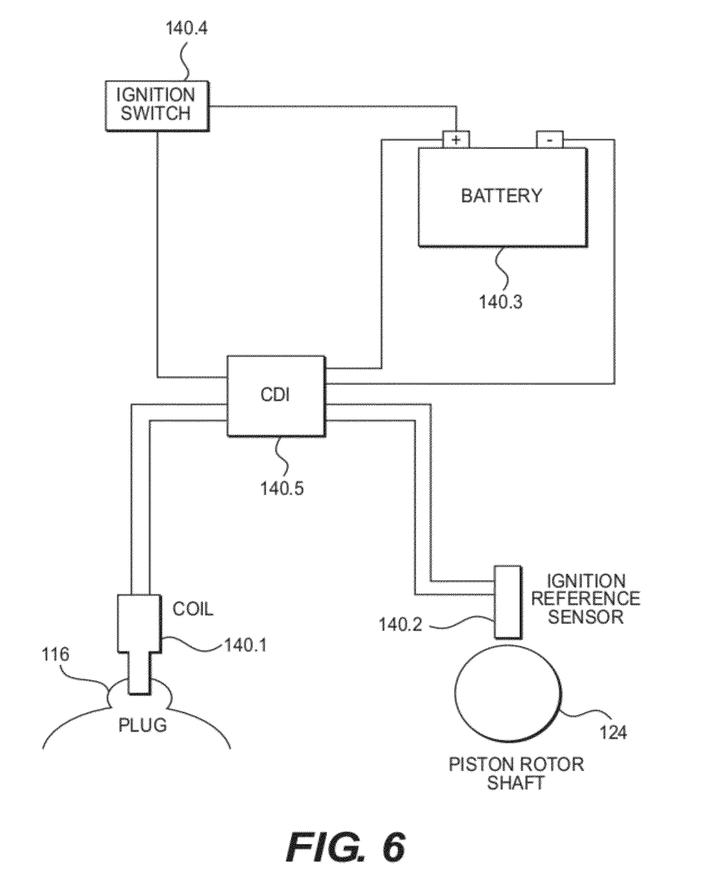

As shown in FIG. 6, spark ignition is effected thru the use of a capacitor discharge ignition (CDI) solid state ignition because it is currently considered more satisfactory for high rpm engines. It consists of plug/coil module 140.1 installed in the area directly under the powerhead, a CDI ignition module 140.5 to provide the necessary voltage 140, an ignition reference sensor 140.2 mounted on the piston rotor shaft 124 to provide timing of the spark, a battery/alternator 140.3 to provide initial voltage and an ignition switch 140.4 to turn the system on and off.

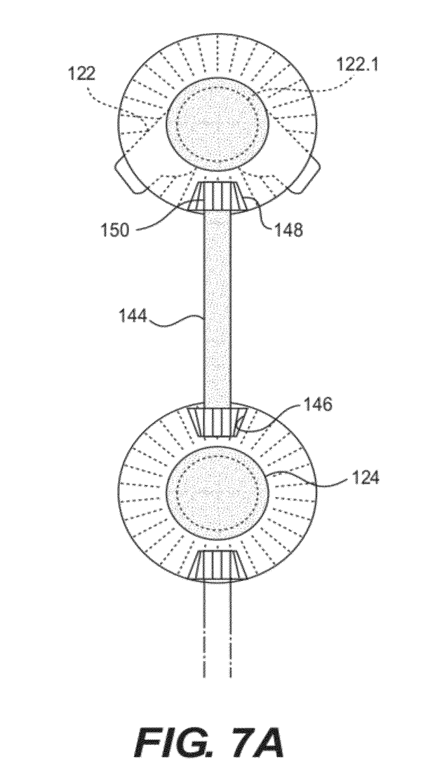

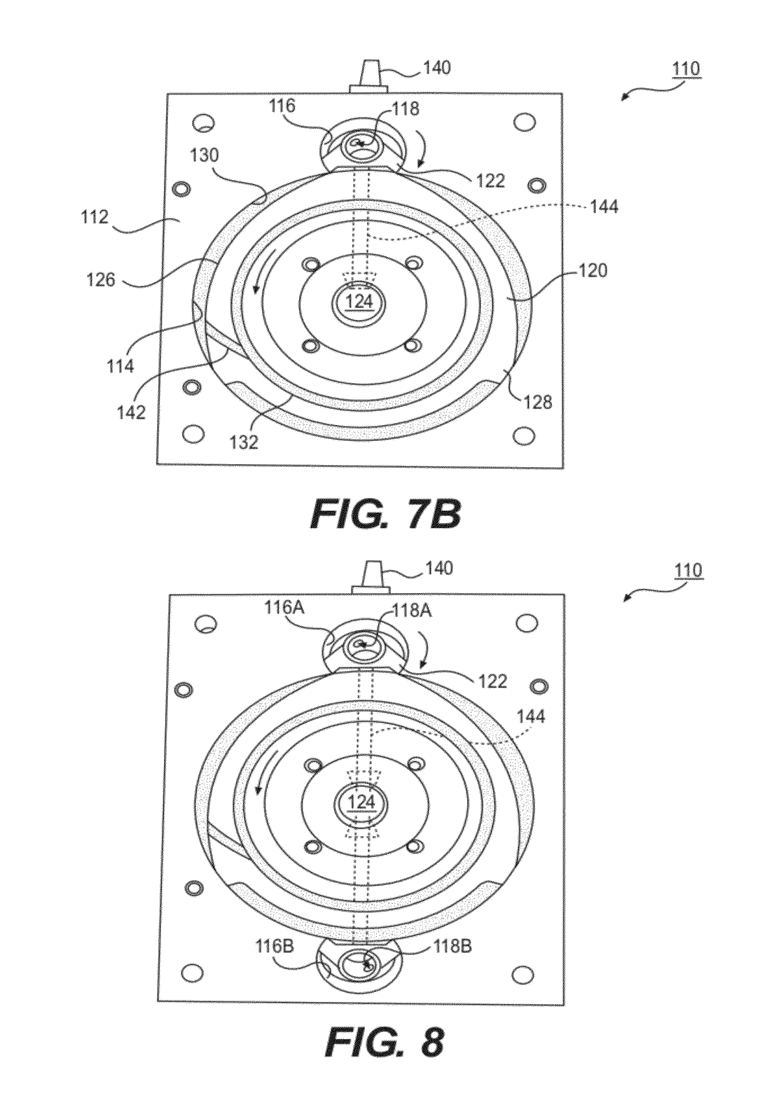

As shown in FIG. 7A, the gear train 144 consist of a bevel gear 146 mounted and keyed to the main rotor shaft 124, a similar bevel gear 148 mounted and keyed to the power head shaft, and a shaft with bevel gears 150 mounted on each end to mesh with the gears on the main rotor shaft 124 and the power head shaft 122.1. This gear train, properly mounted on the rear case on the rotary engine will cause the piston rotor and the powerhead to maintain the proper angular relationship 1:1 ratio. The piston rotor and the power head maintain a precise rotational relationship 1:1 ratio with each other thru a gear train mounted externally to this chamber (not shown) . The piston rotor rotates counter clockwise while the power head rotates clockwise.

As shown in FIG. 7B, a gear train 144 (in phantom) mates the piston rotor shaft 124 and the power head 122, so that they are timed to maintain the proper angular relationship 1:1 ratio. The piston rotor 124 and the power head 122 maintain a precise rotational relationship 1:1 ratio with each other thru a gear train mounted externally to this chamber. The piston rotor 124 rotates counter clockwise while the power head rotates clockwise.

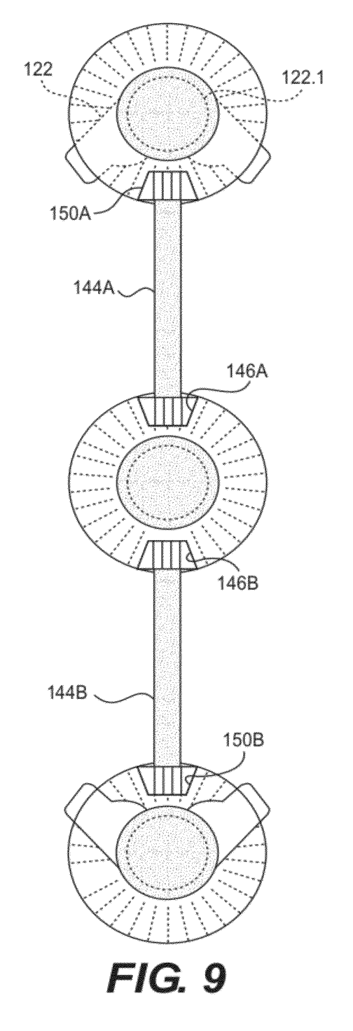

As shown in FIGS. 8-9: the rotary engine herein described can be fabricated with multiple power heads 122 (first head 116A/118A and second head 116B/118B) (via 2 gear coupling 146A, 146B aligned in a same axis) in the casing with a single piston rotor shaft 124. It can also be fabricated with multiple piston rotor/powerhead combinations on a common main shaft and powerhead shafts with a common gear train 144A-144B. The piston rotor and the first power head maintain a precise rotational relationship 1:1 ratio with each other thru a gear train mounted externally to this chamber (not shown). The piston rotor rotates counter clockwise while the two power heads rotates clockwise.

It will be understood that each of the elements described above, or two or more together, may also find a useful application in other types of constructions differing from the types described above.

While the invention has been illustrated and described as embodiments of a rotary engine, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A rotary engine which comprises:
a) a casing having a large circular boring and a small circular boring, whereby the small circular boring interconnects with the large circular boring;
b) a piston rotor carried in a rotating manner within the large circular boring in the casing; and
c) a power head ported to vent exhaust gases into the hollow center shaft carried in a rotating manner within the small circular boring in the casing, whereby the piston rotor and the power head are meshed together to properly rotate during operation, with the piston rotor rotating counterclockwise and the power head rotating clockwise.

2. The rotary engine as recited in claim 1, further comprising a shaft extending centrally from the piston rotor for power output therefrom with power output also available from the power head shaft.

3. The rotary engine as recited in claim 2, further comprising:
a) the piston rotor having a depression formed on its circumference to produce a compression chamber between the depression and the large circular boring in the casing; and
b) a centrifugal pump involute vane and collector ring integrated on the piston rotor that can move fresh air and fuel into the compression chamber.

4. The rotary engine as recited in claim 3, further comprising:
a) a front plate mounted onto the casing; and
b) a carburetor having a fresh air intake stem affixed onto the front plate to supply a fuel air mixture into the collector ring.

5. The rotary engine as recited in claim 1, further comprising a CDI solid state ignition system on the casing that can fire the fuel air mixture in the compression chamber, whereby the exhaust gases can travel through the power head and exit out of the exhaust port in the power head to it's hollow center shaft.

6. The rotary engine as recited in claim 5, wherein the CDI solid state ignition system further includes:
a plug/coil module installed in the area directly under the powerhead,
a CDI ignition module to provide a necessary voltage, an ignition reference sensor mounted on the piston rotor shaft to provide timing of the spark,
a battery/alternator to provide an initial voltage and an ignition switch to turn the CDI system on and off.

7. The rotary engine as recited in claim 1, wherein the casing is comprised out of a suitable durable material.

8. The rotary engine as recited in claim 7, wherein the suitable durable material is aluminum.

9. The rotary engine as recited in claim 7, wherein the suitable durable material is steel.

10. The rotary engine as recited in claim 7, wherein the suitable durable material is ceramic.

11. The rotary engine as recited in claim 1, wherein the rotary engine can have the size of 8 inches (W) , 10 inches (L) and 12 inches (H).

12. The rotary engine as recited in claim 1, wherein the rotary engine can rotate from 300 revolution per minutes (rpm) to 20,000 rpm.

13. The rotary engine as recited in claim 1, wherein the volume's compression chamber can be 50 cc-5000 cc.

14. A rotary engine which comprises:
a) a casing having a large circular boring and a small circular boring, whereby the small circular boring interconnects with the large circular boring;
b) a piston rotor carried in a rotating manner within the large circular boring in the casing;
c) a first power head ported to vent exhaust gases into the hollow center shaft carried in a rotating manner within the small circular boring in the casing, whereby the piston rotor and the power head are meshed together to properly rotate during operation, with the piston rotor rotating counterclockwise and the power head rotating clockwise; and
d) a second power head symmetrically located and ported to vent exhaust gases into the hollow center shaft carried in a rotating manner within the small circular boring in the casing, whereby the piston rotor and the power head are meshed together to properly rotate during operation, with the piston rotor rotating counterclockwise and the second power head rotating clockwise.

15. The rotary engine as recited in claim 14, wherein the rotary engine can have the size of 8 inches (W), 10 inches (L) and 12 inches (H).

16. The rotary engine as recited in claim 14, wherein the rotary engine can rotate from 300 revolution per minutes (rpm) to 20,000 rpm.

17. The rotary engine as recited in claim 14, wherein the volume's compression chamber can be 50 cc-5000 cc.

18. The rotary engine as recited in claim 14, wherein the casing is comprised out of aluminum.

19. The rotary engine as recited in claim 14, wherein the suitable durable material is steel.

20. The rotary engine as recited in claim 14, wherein the suitable durable material is ceramic.
